(19) United States
(12) Patent Application Publication
(10) Pub. No.: US 2026/0095856 A1
(43) Pub. Date: Apr. 2, 2026

(54) CONTROL METHOD AND ELECTRONIC DEVICE

(71) Applicant: Lenovo (Beijing) Limited, Beijing (CN)

(72) Inventors: Xueli BAN, Beijing (CN); Qihua Xiao, Beijing (CN); Zhijian Mo, Beijing (CN)

(21) Appl. No.: 19/341,706

(22) Filed: Sep. 26, 2025

(30) Foreign Application Priority Data
Sep. 29, 2024 (CN) 202411375845.9

(51) Int. Cl. H04W 52/02

(52) U.S. Cl. CPC H04W 52/0209

(57) ABSTRACT

A control method includes: receiving, via a processing unit in an electronic device, state parameters of the electronic device and/or running applications; determining, via the processing unit, a first target parameter and a second target parameter based on the state parameters and/or running applications, the first target parameter being used to determine a first power consumption parameter controlled by a first control unit, and the second target parameter being used to determine a second power consumption parameter controlled by a second control unit; in response to the processing unit sending the first target parameter to the first control unit, adjusting, via the first control unit, the first power consumption parameter based on the first target parameter; in response to the processing unit sending the second target parameter to the second control unit, adjusting, via the second control unit, the second power consumption parameter based on the second target parameter.

### CROSS-REFERENCE TO RELATED APPLICATION(S)

This application claims priority to Chinese Patent Application No. 2024113758459 filed on Sep. 29, 2024, which is incorporated herein by reference in its entirety.

### FIELD OF THE TECHNOLOGY

The present disclosure relates to a field of computer technology, and in particular to a control method and electronic device.

### BACKGROUND

During the use of electronic devices such as laptops and tablets, the power consumption parameters of these devices may be adjusted using the devices'built-in dynamic tuning technology (DTT) and a custom resource control system to help ensure normal operation while saving power. However, setting power consumption parameters concurrently with both DTT and the resource control system may cause conflicts. Because the power consumption parameter settings may rely on the same power level, multiple power consumption parameters may affect each other. Furthermore, certain existing power consumption parameter adjustment processes may be lengthy and inefficient.

### SUMMARY

In one aspect, the present disclosure provides a control method. The method includes: receiving, via a processing unit in an electronic device, state parameters of the electronic device and/or running applications, the state parameters representing an operating state of at least one component in the electronic device; determining, via the processing unit, a first target parameter and a second target parameter based on the state parameters and/or running applications, the first target parameter being used to determine a first power consumption parameter controlled by a first control unit, and the second target parameter being used to determine a second power consumption parameter controlled by a second control unit; in response to the processing unit sending the first target parameter to the first control unit, adjusting, via the first control unit, the first power consumption parameter based on the first target parameter; in response to the processing unit sending the second target parameter to the second control unit, adjusting, via the second control unit, the second power consumption parameter based on the second target parameter.

In another aspect, the present disclosure provides an electronic device. The device includes: a memory storing computer program instructions; and a processor coupled to the memory and configured to execute the computer program instructions and perform: receiving, via a processing unit in an electronic device, state parameters of the electronic device and/or running applications, the state parameters representing an operating state of at least one component in the electronic device; determining, via the processing unit, a first target parameter and a second target parameter based on the state parameters and/or running applications, the first target parameter being used to determine a first power consumption parameter controlled by a first control unit, and the second target parameter being used to determine a second power consumption parameter controlled by a second control unit; in response to the processing unit sending the first target parameter to the first control unit, adjusting, via the first control unit, the first power consumption parameter based on the first target parameter; in response to the processing unit sending the second target parameter to the second control unit, adjusting, via the second control unit, the second power consumption parameter based on the second target parameter.

In yet another aspect, the present disclosure provides a non-transitory computer-readable storage medium storing computer program instructions executable by at least one processor to perform: receiving, via a processing unit in an electronic device, state parameters of the electronic device and/or running applications, the state parameters representing an operating state of at least one component in the electronic device; determining, via the processing unit, a first target parameter and a second target parameter based on the state parameters and/or running applications, the first target parameter being used to determine a first power consumption parameter controlled by a first control unit, and the second target parameter being used to determine a second power consumption parameter controlled by a second control unit; in response to the processing unit sending the first target parameter to the first control unit, adjusting, via the first control unit, the first power consumption parameter based on the first target parameter; in response to the processing unit sending the second target parameter to the second control unit, adjusting, via the second control unit, the second power consumption parameter based on the second target parameter.

### BRIEF DESCRIPTION OF THE DRAWINGS

Objects, features, and advantages of certain embodiments of the present disclosure may become readily apparent by reading the following detailed description with reference to the accompanying drawings. The accompanying drawings illustrate certain embodiments of the present disclosure by way of example and not limitation.

In the accompanying drawings, identical or corresponding reference numerals may reflect identical or corresponding parts.

FIG. 1 illustrates a flow chart of a control method according to certain embodiments of the present disclosure;

FIG. 2 illustrates a diagram of a control method according to certain embodiments of the present disclosure;

FIG. 3 illustrates a flow chart of a control method according to certain embodiments of the present disclosure;

FIG. 4 illustrates a flow chart of a control method according to certain embodiments of the present disclosure; and

FIG. 5 illustrates a schematic diagram of the structural components of an electronic device according to certain embodiments of the present disclosure.

### DETAILED DESCRIPTION

To make the objectives, features, and advantages of this disclosure more apparent and understandable, the following clearly and completely describes the technical solutions in the embodiments of this disclosure, in conjunction with the accompanying drawings. The embodiments described represent only a portion of the embodiments of this disclosure, and not all of them. All other embodiments derived by those skilled in the art based on the embodiments of this disclosure without inventive effort are within the scope of protection of this disclosure.

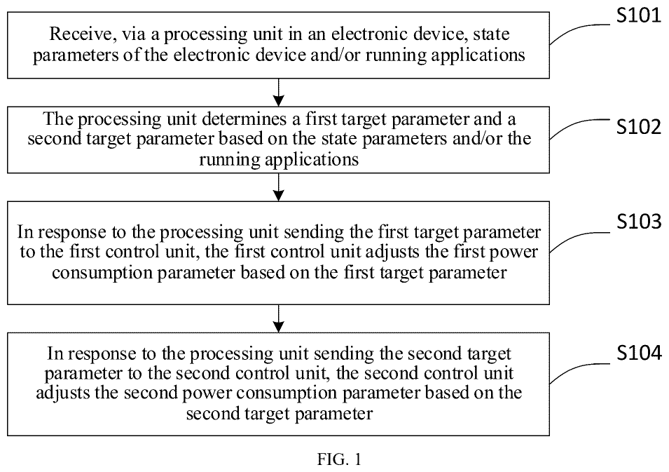

FIG. 1 shows a flow chart of a control method according to certain embodiments of this disclosure. As shown in FIG. 1, the control method includes:

S101: Receive, via a processing unit in an electronic device, state parameters of the electronic device and/or running applications.

In certain embodiments, the state parameters of the electronic device represent the operating state of at least one component in the electronic device, including battery voltage, single roast or double roast state, thermal sensor value, power state, system state, graphics card state and hotplug state, or the like, where single roast refers to a scenario in which the electronic device is only in a central processing unit (CPU) intensive operation such as video encoding or scientific computing, or only in a graphics processing unit (GPU) intensive operation such as gaming or graphics rendering software, and double roast refers to a scenario in which the electronic device is simultaneously in a CPU intensive operation and a GPU intensive operation; the thermal sensor value may represent the temperature around the thermal sensor in the electronic device; the power state includes a direct current (DC) state and an alternating current (AC) state; the system state includes a working state (S0, Working), a low power standby state (S1, SlEPPing 1), a relatively low power standby state (S2, SlEPPing 2), and a sleep state (S3, Suspend to The graphics card state includes the integrated graphics state and the discrete graphics state. The integrated graphics state may be implemented by the Unified Memory Architecture (UMA), and the discrete graphics state may use the discrete graphics processing unit (DGPU). The hot-plug state mainly refers to the enabled state of the DGPU. For example, the DGPU may be enabled in a gaming scenario and disabled in an office scenario. These state parameters and the applications running on the electronic device may be used to determine the power consumption of the electronic device. The processing unit in the electronic device is a unit that may determine the power consumption of the electronic device based on the state parameters and the applications running on the electronic device.

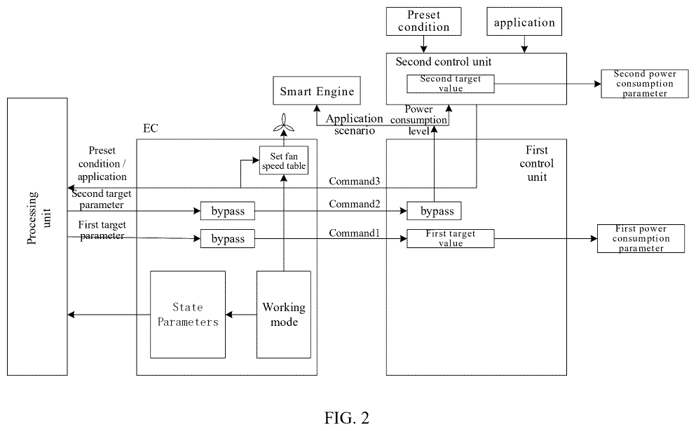

FIG. 2 illustrates a scenario diagram of a control method according to certain embodiments of the present disclosure. As shown in FIG. 2, the processing unit may obtain state parameters of the electronic device from the embedded controller (EC) of the electronic device and may obtain running applications from a second control unit in the electronic device. The second control unit may transmit the applications to the processing unit via Command 3. In one example, the processing unit may be an AI chip capable of determining the power consumption of the electronic device based on the state parameters and the applications. The second control unit may be a task scheduler capable of determining the applications running in the electronic device. The dispatcher is responsible for determining the application to be run.

S102: The processing unit determines a first target parameter and a second target parameter based on the state parameters and/or the running applications.

In certain embodiments, the processing unit may determine target parameters corresponding to the electronic device based on the state parameters and/or the running applications. The target parameters may be used to determine the power consumption parameters of the electronic device, such as the power limit, performance, and frequency of the CPU in the electronic device, as well as the power distribution and total graphics power (TGP) of the GPU in the electronic device. The CPU power limit includes long-term operation power (PL1), short-term turbo power (PL2), instantaneous turbo power (PL3), and power ceiling (PL4). PL3 is generally not open to the public and may be ignored in certain embodiments. The performance of the CPU may be reflected through an enhanced performance profile (EPP). The EPP allows users or system administrators to set CPU performance preferences, thereby affecting the response performance of the CPU under different workloads. The lower the EPP value, the more performance-oriented the electronic device is, and the higher the EPP value, the more energy-saving the electronic device is. The power distribution of the GPU is achieved through dynamic acceleration (Dynamic Boost) technology, also known as Power Performance Adaptive Boost (PPAB) technology, which may adjust the power distribution between the CPU and GPU of the electronic device. Due to the limitations of the control interface, power consumption parameters of the electronic device may not be completed by only one control unit. For example, software-level parameters such as the CPU's EPP and Frequency may not be controlled at the hardware level through the first control unit, and may only be controlled by the second control unit from the software level. That is, the first control unit is used to control the first power consumption parameters at the hardware level, such as PL1, PL2 in the CPU's power consumption limit and TGP, PPAB and other power consumption parameters of the GPU, and the second control unit is used to control the second power consumption parameters at the software level, such as the CPU's EPP, Frequency and PL4 and other power consumption parameters. Therefore, it may be desirable to classify the target parameters, and determine the target parameters among the target parameters for determining the first power consumption parameters controlled by the first control unit as the first target parameters, and determine the target parameters among the target parameters for determining the second power consumption parameters controlled by the second control unit as the second target parameters.

As shown in FIG. 2, the first control unit may be the Basic Input/Output System (BIOS) of an electronic device. The BIOS is used to control first power consumption parameters, such as PL1 and PL2 in the CPU's power consumption limits and TGP and PPAB for the GPU. The second control unit may be a dispatcher, which is used to control second power consumption parameters, such as EPP, Frequency, and PL4 for the CPU. In certain embodiments, the first control unit does not have control over the second power consumption parameters, and the second control unit does not have control over the first power consumption parameters.

S103: In response to the processing unit sending the first target parameter to the first control unit, the first control unit adjusts the first power consumption parameter based on the first target parameter.

In certain embodiments, after determining the first and second target parameters based on state parameters and/or running applications, the processing unit may send the first target parameter to the first control unit. The first control unit may determine the value of the first power consumption parameter based on the first target parameter, thereby adjusting the first power consumption parameter. As shown in FIG. 2, the processing unit may send the first target parameter to the BIOS of the first control unit via Command 1, and the first control unit may adjust the first power consumption parameter based on the first target parameter. The bypass in FIG. 2 represents transmission only. For example, the first target parameter is bypassed through the EC, indicating that the EC is only used to transmit the first target parameter to the first control unit BIOS without any processing.

S104: In response to the processing unit sending the second target parameter to the second control unit, the second control unit adjusts the second power consumption parameter based on the second target parameter.

In certain embodiments, after determining the first target parameter and the second target parameter based on state parameters and/or running applications, the processing unit may send the second target parameter to the second control unit. The second control unit may determine the value of the second power consumption parameter based on the second target parameter, thereby adjusting the second power consumption parameter. As shown in FIG. 2, the processing unit may send the second target parameter to the second control unit Dispatcher using Command2, and the Dispatcher may adjust the second power consumption parameter based on the second target parameter.

In certain embodiment, the processing unit AI Chip and the second control unit Dispatcher together form a customized resource control system. The processing unit AI Chip determines the target parameters that determine the power consumption parameters of the electronic device. Different control units adjust the power consumption parameters based on the target parameters. This avoids conflicts that may arise when the DTT and the customized resource control system simultaneously set power consumption parameters. Furthermore, since the target parameters are determined based on the electronic device's state parameters and/or running applications, the settings of all target parameters are not solely dependent on the same power consumption level. Therefore, multiple power consumption parameters do not affect each other, helping ensure the accuracy of the adjusted power consumption parameters. Furthermore, the adjustment path for the power consumption parameters corresponding to different control units may only need to pass through the processing unit and the control unit, reducing the need for parameter conversion in other control units. This reduces the length of the adjustment path and improves adjustment efficiency.

In certain embodiments, S102, “Determine, by the processing unit, the first target parameter and the second target parameter based on the state parameter,” includes:

Determining, by the processing unit, the target parameters for determining the power consumption of the electronic device based on the state parameter, the target parameters including the power consumption level of the electronic device; and determining, by the processing unit, the power consumption level within the target parameters as the second target parameter.

In certain embodiments, when the running application has little impact on the power consumption parameters of the electronic device, the processing unit may determine the target parameters required for determining the power consumption of the electronic device based only on the state parameters of the electronic device. The target parameters may include the values of the first power consumption parameters such as PL1, PL2 in the power consumption limit of the CPU and TGP, PPAB of the GPU, and may also include the power consumption level (Power level) of the electronic device. The power consumption level may be used to determine the values of the second power consumption parameters such as EPP, Frequency and PL4 of the CPU. In certain embodiments, the power consumption level may be set to eight levels, and each level is set with corresponding values of parameters such as EPP, Frequency and PL4. After obtaining the target parameters, the values of the first power consumption parameters such as PL1, PL2 in the power consumption limit of the CPU and TGP, PPAB of the GPU may be determined as the first target parameters, and the power consumption level of the electronic device may be determined as the second target parameter.

In certain embodiments, the first target parameters include the values of first power consumption parameters such as PL1, PL2, TGP, and PPAB. Because the first power consumption parameters are correlated with the state parameters of the electronic device, the processing unit may determine the values of first power consumption parameters such as PL1, PL2, TGP, and PPAB based on the state parameters of the electronic device. The second target parameters include the power consumption level of the electronic device, rather than the values of second power consumption parameters such as the CPU's EPP, Frequency, and PL4. This is because the state parameters of the electronic device do not directly affect the values of the second power consumption parameters, and EPP, Frequency, and PL4 do not need to change very frequently. Therefore, the second target parameters only include the power consumption level of the electronic device. The second control unit may then determine the corresponding values of parameters such as EPP, Frequency, and PL4 based on the power consumption level.

In certain embodiments, the battery voltage, a state parameter of the electronic device, is combined with the currents of components such as the CPU, GPU, and solid-state drive (SSD) to calculate the power of the relevant components. When the power of a component is higher, the total power of the electronic device may be tilted toward that component. For example, when the CPU power is higher, the CPU's PL1, PL2, and PL4 values may be higher, and the power consumption level of the electronic device will also be higher. When the GPU power is higher, the GPU's TGP, PPAB, and other values may be higher.

In one possible implementation, the single roast or double roast state in the state parameters of the electronic device, when the electronic device is in the single roast state, the performance of the current main processor may be given priority. For example, when the CPU performance is given priority and the total power consumption of the system is 100 W (watts), then 100 W of power consumption may be supplied to the CPU first according to the CPU's needs. At this time, the values of PL1, PL2 and PL4 of the CPU may be higher, and the power consumption level of the electronic device may be higher. When the electronic device is in the double roast state, the performance of the GPU may be given priority. For example, when the total power consumption of the system is 100 W and the GPU requires 60 W, 60 W of power consumption may be allocated to the GPU first, and the remaining 40 W may be allocated to the CPU. At this time, the values of TGP, PPAB, or the like of the GPU may be higher.

In certain embodiments, a higher thermal sensor value in the electronic device's state parameters indicates a higher internal temperature. To reduce heat generation and prevent further temperature increases, the CPU's PL1, PL2, and PL4 values are set to lower values, resulting in a lower power consumption level for the electronic device. Consequently, the GPU's TGP, PPAB, and other values are also set to lower values.

In certain embodiments, the different system states in the electronic device's state parameters also affect the electronic device's power consumption parameters. For example, in the S0 state, the electronic device operates normally. The CPU's PL1, PL2, and PL4 values, as well as the GPU's TGP, PPAB, and other values, may be determined based on other state parameters. In the S1 state, the electronic device is in standby mode, with the CPU not operating. The CPU's PL1, PL2, and PL4 values, as well as the GPU's TGP, PPAB, and other values, may all be set to lower values.

In one implementation, when the graphics card state in the electronic device's state parameters indicates an integrated graphics state, the values of TGP and PPAB may not be adjusted. When the graphics card state in the electronic device's state parameters indicates a discrete graphics state, the GPU's power consumption may be prioritized, for example, the GPU's TGP, PPAB, and other values may be set higher.

In certain embodiments, the hotplug state in the electronic device's state parameters refers to the DGPU's enabled state. For example, the DGPU may be automatically enabled in gaming scenarios and disabled in office scenarios. When the DGPU is enabled, the GPU's power consumption may be prioritized, for example, the GPU's TGP, PPAB, and other values may be set higher.

In certain embodiments, the state parameters include the operating state of at least one processor, including at least one of a central processing unit and a graphics processing unit. “Determining, by the processing unit, target parameters for determining the power consumption parameters of the electronic device based on the state parameters” includes:

Determining, by the processing unit, target power consumption parameters corresponding to the at least one processor based on the total power consumption of the electronic device and the operating state of the at least one processor.

In certain embodiments, the battery voltage, single roast or double roast state, thermal sensor value, power supply state, and system state in the state parameters are related to the operating state of the CPU and GPU. The graphics card state and hotplug state are related to the operating state of the GPU. When the state parameters determine that the electronic device is operating in the CPU state, the target parameters corresponding to the CPU, such as the CPU's PL1 and PL2 values and the CPU's power consumption level, are prioritized. The GPU's power consumption is then determined based on the electronic device's total power consumption and the CPU's power consumption, and the values of the GPU's TGP and PPAB are then determined. When the state parameters determine that the electronic device is operating in the GPU state, the target parameters corresponding to the GPU, such as the GPU's TGP and PPAB values, are prioritized. The CPU's power consumption is then determined based on the electronic device's total power consumption and the GPU's power consumption, and the values of the CPU's PL1 and PL2 values and the CPU's power consumption level are then determined. This balances power consumption distribution among multiple processors and helps ensure the accuracy of the power consumption parameter values corresponding to multiple processors.

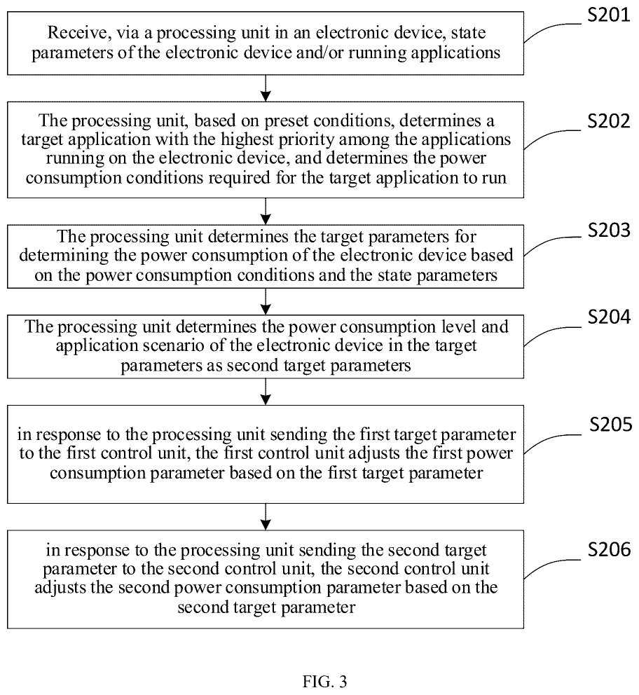

FIG. 3 illustrates a second flow chart of a control method according to certain embodiments of the present disclosure. As shown in FIG. 3, the control method includes:

S201: Receive, via a processing unit in an electronic device, state parameters of the electronic device and/or running applications.

The implementation details of S201 are similar to those of S101 and are not further described here.

S202: The processing unit, based on preset conditions, determines a target application with the highest priority among the applications running on the electronic device, and determines the power consumption conditions required for the target application to run.

In certain embodiments, the second control unit is further configured with preset conditions to characterize the priority of applications in the electronic device. These preset conditions may include an application whitelist, application priority, and applications determined based on Turbo Boost technology. Applications in the application whitelist are prioritized. Based on the preset conditions, the processing unit may determine, based on the preset conditions, the target application with the highest priority among the applications running on the electronic device. The power consumption parameters of the electronic device must prioritize meeting the power consumption conditions required for the target application to run. The power consumption conditions may be pre-set. As shown in FIG. 2, the second control unit, Dispatcher, may simultaneously send the preset conditions and applications to the processing unit AI Chip via Command 3.

In one example, when the processing unit determines the first and second target parameters based solely on the state parameters, generally, when the electronic device's power consumption is high, the CPU's power consumption parameters (PL1, PL2, EPP, Frequency) and the GPU's power consumption parameters (TGP, PPAB) may be higher. However, when the electronic device is running a program on an application whitelist and requires minimal power consumption to reduce fan noise, even when the power consumption of the electronic device is higher based on the state parameters, the power consumption parameters (PL1, PL2, and EPP) will need to be set lower. This helps ensure that the system's power consumption parameters prioritize applications with higher priority, improving the user experience.

S203: The processing unit determines the target parameters for determining the power consumption of the electronic device based on the power consumption conditions and the state parameters.

In certain embodiments, after determining the power consumption conditions required for running the target application, the processing unit may determine target parameters for determining the power consumption parameters of the electronic device based on the power consumption conditions and state parameters. The target parameter determination process prioritizes satisfying the power consumption conditions and then considers the impact of the state parameters. The target parameters may include values of first power consumption parameters such as PL1 and PL2 in the CPU power consumption limits and TGP and PPAB in the GPU. They may also include the power consumption level and implementation scenario of the electronic device.

S204: The processing unit determines the power consumption level and implementation scenario of the electronic device in the target parameters as second target parameters.

In certain embodiments, the implementation scenarios of the electronic device may include gaming, office, and video scenarios. The implementation scenarios may also be used to determine the values of second power consumption parameters such as the CPU's EPP, Frequency, and PL4. For example, in gaming scenarios, the EPP value may be lower, favoring performance, while the Frequency and PL4 values may be higher, thereby increasing the game frame rate and maximum power limit. In office scenarios, the EPP value may be higher, favoring energy conservation, while the Frequency and PL4 values may be lower, thereby saving power and reducing heat. Therefore, it is desirable to determine the values of the first power consumption parameters such as PL1, PL2 of the CPU and TGP, PPAB of the GPU in the target parameters as the first target parameters, and determine the current power consumption level and implementation scenario of the electronic device as the second target parameters.

In S205, in response to the processing unit sending the first target parameter to the first control unit, the first control unit adjusts the first power consumption parameter based on the first target parameter.

In S206, in response to the processing unit sending the second target parameter to the second control unit, the second control unit adjusts the second power consumption parameter based on the second target parameter.

The implementation details of S205 and S206 are similar to those of S103 and S104 and are not further described here.

In certain embodiments, S203, “determining, by the processing unit, target parameters for determining the power consumption of the electronic device based on the power consumption condition and the state parameter,” includes:

Determining, by the processing unit, a target model for determining the target parameter based on a power state in the state parameter, the power state including a first state and a second state, the power requirement of the first model corresponding to the first state being less than the power requirement of the second model corresponding to the second state; and determining, based on the target model and the power consumption condition and the state parameter, the target parameter required for determining the power consumption of the electronic device.

In certain embodiments, the power state in the state parameter includes a first state and a second state, where the first state may be a DC state and the second state may be an AC state. In the DC state, the electronic device aims at energy saving, and in the AC state, the electronic device aims at performance. Therefore, the power demand required by the first model corresponding to the first state is less than the power demand required by the second model corresponding to the second state. The target models used to determine the target parameters in the first state and the second state may be different. In the first state, the target model may be a smart battery life model (Smart Battery Life model). The Smart Battery Life model may extend battery life while providing sufficient performance to meet user needs. In the second state, the target model may be an adaptive performance model (AP, Adaptive Performance Model). The AP model may maximize performance while maintaining reasonable temperature and power consumption. The target models in different power states may determine the target parameters required for determining the power consumption of the electronic device under the current power supply through power consumption conditions and state parameters, thereby improving the accuracy and reliability of the target parameters.

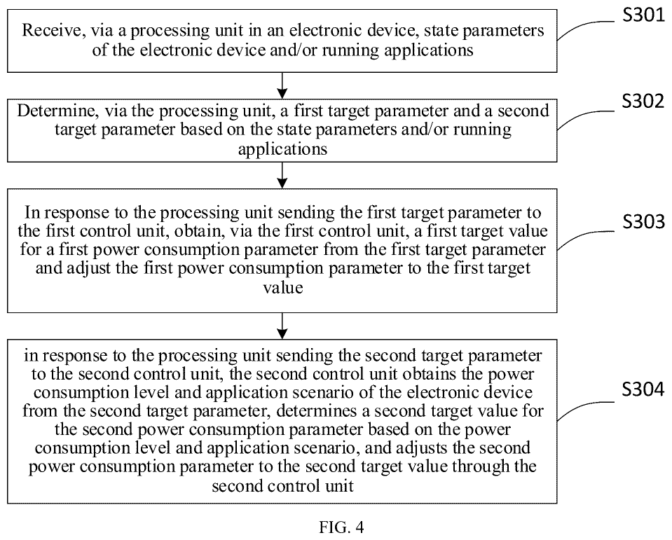

FIG. 4 illustrates a third flow chart of a control method according to certain embodiments of the present disclosure. As shown in FIG. 4, the control method includes:

S301: Receive, via a processing unit in an electronic device, state parameters of the electronic device and/or running applications.

S302: Determine, via the processing unit, a first target parameter and a second target parameter based on the state parameters and/or running applications.

The implementation details of S301 and S302 are similar to those of S101 and S102 and are not further described here.

S303: In response to the processing unit sending the first target parameter to the first control unit, obtain, via the first control unit, a first target value for a first power consumption parameter from the first target parameter and adjust the first power consumption parameter to the first target value.

In certain embodiments, the first target parameters include the values of first power consumption parameters such as PL1, PL2, TGP, and PPAB. Because the first power consumption parameters are correlated with the state parameters of the electronic device, the processing unit may determine the values of the first power consumption parameters such as PL1, PL2, TGP, and PPAB based on the state parameters of the electronic device. After the processing unit sends the first target parameters to the first control unit, the first control unit may obtain the first target values of the first power consumption parameters from the first target parameters and adjust the first power consumption parameters to the first target values.

As shown in FIG. 2, the processing unit sends the first target parameters to the first control unit via Command 1. The first control unit obtains the first target values of the first power consumption parameters from the first target parameters and adjusts the first power consumption parameters based on the first target values.

In S304, in response to the processing unit sending the second target parameter to the second control unit, the second control unit obtains the power consumption level and implementation scenario of the electronic device from the second target parameter, determines a second target value for the second power consumption parameter based on the power consumption level and implementation scenario, and adjusts the second power consumption parameter to the second target value through the second control unit.

In certain embodiments, the second target parameter includes the power consumption level and implementation scenario of the electronic device, rather than the values of the second power consumption parameters such as the CPU's EPP, Frequency, and PL4. This is because the state parameters of the electronic device do not directly affect the values of the second power consumption parameters, and EPP, Frequency, and PL4 do not need to change frequently. Therefore, the second target parameter includes the power consumption level and implementation scenario of the electronic device. The second control unit may then determine corresponding second target values for parameters such as EPP, Frequency, and PL4 based on the power consumption level and implementation scenario, and adjust the second power consumption parameters based on the second target values.

In certain embodiments, the power consumption level may be set to eight levels, and each level is provided with corresponding values of parameters such as EPP, Frequency and PL4. The second target values of the corresponding parameters such as EPP, Frequency and PL4 may be determined according to the power consumption level; the implementation scenarios may be game scenarios, office scenarios and video scenarios, or the like In the game scenario, the second target value of EPP may be lower, making the electronic device more performance-oriented, while the second target values of Frequency and PL4 may be higher, thereby increasing the game frame rate and maximum power limit; in the office scenario, the second target value of EPP may be higher, making the electronic device more energy-saving, while the second target values of Frequency and PL4 may be lower, thereby saving power consumption and reducing heat.

In certain embodiments, as shown in FIG. 2, the processing unit sends the second target parameter to the second control unit via Command 2. The power consumption level may be sent to the second control unit, and the implementation scenario may be sent to the smart engine. The second control unit and the smart engine jointly determine the second target value of the second power consumption parameter.

In certain embodiments, a control method further includes:

In response to switching the operating mode of the electronic device, triggering the processing unit in the electronic device to receive state parameters of the electronic device and/or running applications.

In certain embodiments, the operating mode of the electronic device is a power management mode of the electronic device, including Balanced Power Saving Mode (BSM), Intelligent Mode (INT), and Enhanced Performance Mode (EPM). BSM prioritizes energy saving, INT seeks an optimal balance between energy saving and performance, and EPM prioritizes performance. After switching the operating mode of the electronic device, power consumption parameters such as PL1, PL2, EPP, and Frequency of the electronic device may need to be reset. Therefore, it is necessary to trigger the processing unit in the electronic device to receive the state parameters of the electronic device and/or running applications, and subsequently adjust the power consumption parameters based on the state parameters and/or running applications. As shown in FIG. 2, after the electronic device switches its operating mode, the EC generates new state parameters, and the second control unit also generates new preset conditions and/or applications. The EC and the second control unit may respectively send the state parameters and the preset conditions and/or applications to the processing unit.

In certain embodiments, responding to the electronic device switching its operating mode includes at least one of the following: responding to the electronic device switching its operating mode based on a user's mode switching instruction. For example, when a user wishes to switch the electronic device's operating mode, they may trigger the mode switching instruction using a corresponding triggering method of the electronic device, and the electronic device switches its operating mode in response to the mode switching instruction; responding to a change in an operating mode flag in the electronic device's power management module. For example, the power management module stores the electronic device's operating mode flag, and when the operating mode changes, the operating mode flag also changes accordingly; responding to a change in a state parameter of the electronic device exceeding a first threshold. For example, when a state parameter related to the operating mode of the electronic device, such as the battery voltage or temperature, changes significantly, it is considered that the operating mode has changed; responding to receiving a switching signal indicating a switch in the electronic device's operating mode. For example, after the electronic device switches its operating mode, the power management module or other related modules may issue a switching signal to indicate the change in the electronic device's operating mode.

In certain embodiments, as shown in FIG. 2, the EC may also set a fan speed table (Fan Table) based on the electronic device's operating mode and running applications. The Fan Table defines the relationship between the electronic device's fan speed and temperature or other state parameters, enabling better temperature control, noise management, and energy efficiency.

According to certain embodiments of the present disclosure, the present disclosure also provides an electronic device and a readable storage medium.

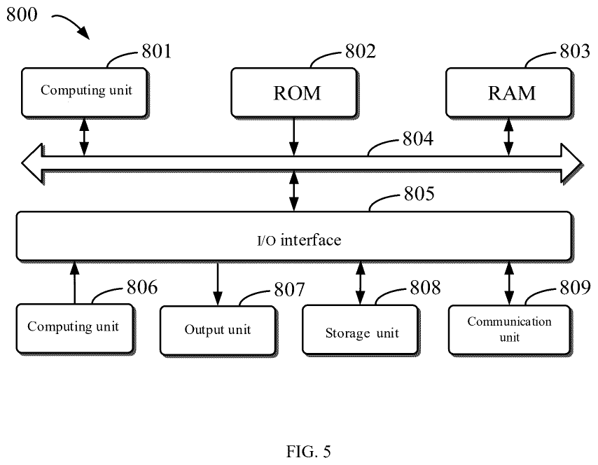

In certain embodiments, FIG. 5 shows a schematic block diagram of an electronic device 800 that may be used to implement certain embodiments of the present disclosure. The electronic device is intended to represent various forms of digital computers, such as laptops, desktop computers, workstations, personal digital assistants, servers, blade servers, mainframe computers, and other suitable computers. The electronic device may also represent various forms of mobile devices, such as personal digital assistants, cellular phones, smartphones, wearable devices, and other similar computing devices. The components shown herein, their connections and relationships, and their functions are provided as examples only and are not intended to limit the implementation of the present disclosure described and/or claimed herein.

As shown in FIG. 5, device 800 includes a computing unit 801, which may perform various appropriate actions and processes according to a computer program stored in a read-only memory (ROM) 802 or loaded from a storage unit 808 into a random access memory (RAM) 803. RAM 803 may also store various programs and data required for the operation of device 800. Computing unit 801, ROM 802, and RAM 803 are interconnected via a bus 804. An input/output (I/O) interface 805 is also connected to bus 804.

Several components within device 800 are connected to I/O interface 805, including an input unit 806, such as a keyboard and mouse; an output unit 807, such as various types of displays and speakers; a storage unit 808, such as a magnetic disk or optical disk; and a communication unit 809, such as a network card, a modem, or a wireless communication transceiver. Communication unit 809 allows device 800 to exchange information/data with other devices via a computer network such as the Internet and/or various telecommunication networks.

The computing unit 801 may be any general-purpose and/or specialized processing component with processing and computing capabilities. Some examples of the computing unit 801 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, or the like. The computing unit 801 performs the various methods and processes described above, such as a control method. For example, in certain embodiments, a control method may be implemented as a computer software program tangibly embodied in a machine-readable medium, such as the storage unit 808. In certain embodiments, part or all of the computer program may be loaded and/or installed onto the device 800 via the ROM 802 and/or the communication unit 809. When the computer program is loaded into the RAM 803 and executed by the computing unit 801, one or more steps of the control method described above may be performed. In certain embodiments, the computing unit 801 may be configured to perform a control method through any other suitable means (for example, via firmware).

Various embodiments of the systems and techniques described above may be implemented in digital electronic circuit systems, integrated circuit systems, field programmable gate arrays (FPGAs), application specific integrated circuits (ASICs), application specific standard products (ASSPs), system-on-chip systems (SOCs), programmable logic devices (CPLDs), computer hardware, firmware, software, and/or combinations thereof. These various embodiments may include being implemented in one or more computer programs that are executable and/or interpreted on a programmable system that includes at least one programmable processor, which may be a special purpose or general purpose programmable processor that may receive data and instructions from a storage system, at least one input device, and at least one output device, and transmit data and instructions to the storage system, the at least one input device, and the at least one output device.

Program code for implementing the methods of the present disclosure may be written in any combination of one or more programming languages. This program code may be provided to a processor or controller of a general-purpose computer, special-purpose computer, or other programmable data processing device, such that, when executed by the processor or controller, the program code implements the functions/operations specified in the flowcharts and/or block diagrams. The program code may be executed entirely on the machine, partially on the machine, as a stand-alone software package, partially on the machine and partially on a remote machine, or entirely on a remote machine or server.

In the context of the present disclosure, a machine-readable medium may be a tangible medium that may contain or store a program for use by or in connection with an instruction execution system, apparatus, or device. A machine-readable medium may be a machine-readable signal medium or a machine-readable storage medium. Machine-readable media may include, but are not limited to, electronic, magnetic, optical, electromagnetic, infrared, or semiconductor systems, apparatuses, or devices, or any suitable combination of the foregoing. More specific examples of machine-readable storage media include electrical connections based on one or more wires, a portable computer disk, a hard disk, random access memory (RAM), read-only memory (ROM), erasable programmable read-only memory (EPROM or flash memory), optical fibers, a compact disk (CD-ROM), optical storage devices, magnetic storage devices, or any suitable combination of the foregoing.

To provide interaction with a user, the systems and techniques described herein may be implemented on a computer having a display device (for example, a CRT (cathode ray tube) or LCD (liquid crystal display) monitor) for displaying information to the user; and a keyboard and pointing device (for example, a mouse or trackball) through which the user may provide input to the computer. Other types of devices may also be used to provide interaction with the user; for example, feedback provided to the user may be any form of sensory feedback (for example, visual feedback, auditory feedback, or tactile feedback); and input from the user may be received in any form, including acoustic input, voice input, or tactile input.

The systems and techniques described herein may be implemented in a computing system that includes back-end components (for example, as a data server), or a computing system that includes middleware components (for example, an application server), or a computing system that includes front-end components (for example, a user computer with a graphical user interface or web browser through which a user may interact with implementations of the systems and techniques described herein), or a computing system that includes any combination of such back-end, middleware, or front-end components. The components of the system may be interconnected by any form or medium of digital data communication (for example, a communication network). Examples of communication networks include a local area network (LAN), a wide area network (WAN), and the Internet.

A computer system may include clients and servers. The clients and servers are generally remote from each other and typically interact through a communication network. The client-server relationship arises through computer programs running on the respective computers and having a client-server relationship with each other. The server may be a cloud server, a server in a distributed system, or a server integrated with a blockchain.

Various forms of the flow shown above may be used, with steps reordered, added, or deleted. For example, the steps described in this disclosure may be executed in parallel, sequentially, or in a different order, as long as the desired results of the technical solution disclosed in this disclosure may be achieved, and this document does not impose any restrictions thereon.

Furthermore, the terms “first” and “second” are used for descriptive purposes only and should not be construed as indicating or implying relative importance or implicitly specifying the number of the technical features indicated. Therefore, features such as “first” or “second” may explicitly or implicitly include at least one of such features. In the description of this disclosure, “plurality” means two or more, unless otherwise specifically defined.

The above description reflects certain embodiments of the present disclosure, but the scope of protection of this disclosure is not limited thereto. Any modifications or substitutions that may be readily conceived by persons skilled in the technical field within the technical scope of this disclosure are intended to be covered by the scope of protection of this disclosure. The scope of protection of this disclosure is subject to the scope of protection of the claims.

What is claimed is:

1. A control method, comprising:
receiving, via a processing unit in an electronic device, state parameters of the electronic device and/or running applications, the state parameters representing an operating state of at least one component in the electronic device;
determining, via the processing unit, a first target parameter and a second target parameter based on the state parameters and/or running applications, the first target parameter being used to determine a first power consumption parameter controlled by a first control unit, and the second target parameter being used to determine a second power consumption parameter controlled by a second control unit;
in response to the processing unit sending the first target parameter to the first control unit, adjusting, via the first control unit, the first power consumption parameter based on the first target parameter; and
in response to the processing unit sending the second target parameter to the second control unit, adjusting, via the second control unit, the second power consumption parameter based on the second target parameter.

2. The method according to claim 1, wherein determining, by the processing unit, the first target parameter and the second target parameter based on the state parameters includes:
determining, by the processing unit, target parameters for determining power consumption of the electronic device based on the state parameters, wherein the target parameters include a power consumption level of the electronic device;
determining, by the processing unit, the power consumption level in the target parameters as the second target parameter.

3. The method according to claim 1, wherein determining, by the processing unit, the first target parameter and the second target parameter based on the state parameters and the running applications include:
determining, by the processing unit, based on a preset condition, a target application with the highest priority among the applications running on the electronic device, and determining a power consumption condition for running the target application, wherein the preset condition represents the priority of an application on the electronic device; and
determining, by the processing unit, based on the power consumption condition and the state parameters, the target parameter for determining the power consumption of the electronic device.

4. The method according to claim 3, further comprising:
determining, by the processing unit, the power consumption level and an implementation scenario of the electronic device in the target parameters as the second target parameter.

5. The method according to claim 3, wherein determining, by the processing unit, target parameters for determining the power consumption of the electronic device based on the power consumption conditions and state parameters includes:
determining, by the processing unit, a target model for determining the target parameters based on a power state in the state parameters, wherein the power state includes a first state and a second state, wherein a power requirement of a first model corresponding to the first state is less than a power requirement of a second model corresponding to the second state; and
determining, by the processing unit, the target parameters for determining the power consumption of the electronic device based on the power consumption condition and state parameters, based on the target model.

6. The method according to claim 2, wherein the state parameters include an operating state of at least one processor, the processor including at least one of a central processing unit and a graphics processing unit; and determining, by the processing unit, the target parameters for determining the power consumption parameter of the electronic device based on the state parameters includes:
determining, by the processing unit, the target power consumption parameter corresponding to the at least one processor based on a total power consumption of the electronic device and the operating state of the at least one processor.

7. The method according to claim 1, wherein adjusting, by the first control unit, the first power consumption parameter based on the first target parameter includes:
determining, by the first control unit, a first target value for the first power consumption parameter from the first target parameter, and adjusting the first power consumption parameter to the first target value.

8. The method according to claim 1, wherein adjusting the second power consumption parameter based on the second target parameter by the second control unit includes:
obtaining, by the second control unit, the power consumption level and implementation scenario of the electronic device in the second target parameter, and determining a second target value for the second power consumption parameter based on the power consumption level and implementation scenario; and
adjusting, by the second control unit, the second power consumption parameter to the second target value.

9. The method according to claim 1, further comprising:
in response to switching an operating mode of the electronic device, triggering the processing unit in the electronic device to receive state parameters of the electronic device and/or running applications.

10. An electronic device, comprising: a memory storing computer program instructions; and a processor coupled to the memory and configured to execute the computer program instructions and perform:
receiving, via a processing unit in an electronic device, state parameters of the electronic device and/or running applications, the state parameters representing an operating state of at least one component in the electronic device;
determining, via the processing unit, a first target parameter and a second target parameter based on the state parameters and/or running applications, the first target parameter being used to determine a first power consumption parameter controlled by a first control unit, and the second target parameter being used to determine a second power consumption parameter controlled by a second control unit;
in response to the processing unit sending the first target parameter to the first control unit, adjusting, via the first control unit, the first power consumption parameter based on the first target parameter; and
in response to the processing unit sending the second target parameter to the second control unit, adjusting, via the second control unit, the second power consumption parameter based on the second target parameter.

11. The electronic device of claim 9, wherein determining, by the processing unit, the first target parameter and the second target parameter based on the state parameter includes:
determining, by the processing unit, target parameters for determining power consumption of the electronic device based on the state parameters, wherein the target parameters include a power consumption level of the electronic device; and
determining, by the processing unit, the power consumption level in the target parameters as the second target parameter.

12. The electronic device of claim 9, wherein determining, by the processing unit, the first target parameter and the second target parameter based on the state parameters and the running applications include:
determining, by the processing unit, based on a preset condition, a target application with the highest priority among the applications running on the electronic device, and determining a power consumption condition for running the target application, wherein the preset condition represents the priority of an application on the electronic device; and
determining, by the processing unit, based on the power consumption condition and the state parameters, the target parameter for determining the power consumption of the electronic device.

13. The electronic device of claim 12, wherein the processor is further configured to perform:
determining, by the processing unit, the power consumption level and an implementation scenario of the electronic device in the target parameters as the second target parameter.

14. The electronic device of claim 12, wherein determining, by the processing unit, target parameters for determining the power consumption of the electronic device based on the power consumption conditions and state parameters includes:
determining, by the processing unit, a target model for determining the target parameters based on a power state in the state parameters, wherein the power state includes a first state and a second state, wherein a power requirement of a first model corresponding to the first state is less than a power requirement of a second model corresponding to the second state; and
determining, by the processing unit, the target parameters for determining the power consumption of the electronic device based on the power consumption condition and state parameters, based on the target model.

15. The electronic device of claim 11, wherein the state parameters include an operating state of at least one processor, the processor including at least one of a central processing unit and a graphics processing unit; and determining, by the processing unit, the target parameters for determining the power consumption parameter of the electronic device based on the state parameters includes:
determining, by the processing unit, the target power consumption parameter corresponding to the at least one processor based on a total power consumption of the electronic device and the operating state of the at least one processor.

16. The electronic device of claim 9, wherein adjusting, by the first control unit, the first power consumption parameter based on the first target parameter includes:
determining, by the first control unit, a first target value for the first power consumption parameter from the first target parameter, and adjusting the first power consumption parameter to the first target value.

17. The electronic device of claim 9, wherein adjusting the second power consumption parameter based on the second target parameter by the second control unit includes:
obtaining, by the second control unit, the power consumption level and implementation scenario of the electronic device in the second target parameter, and determining a second target value for the second power consumption parameter based on the power consumption level and implementation scenario; and
adjusting, by the second control unit, the second power consumption parameter to the second target value.

18. The electronic device of claim 9, wherein the processor is further configured to perform:
in response to switching an operating mode of the electronic device, triggering the processing unit in the electronic device to receive state parameters of the electronic device and/or running applications.

19. A non-transitory computer-readable storage medium storing computer program instructions executable by at least one processor to perform:
receiving, via a processing unit in an electronic device, state parameters of the electronic device and/or running applications, the state parameters representing an operating state of at least one component in the electronic device;
determining, via the processing unit, a first target parameter and a second target parameter based on the state parameters and/or running applications, the first target parameter being used to determine a first power consumption parameter controlled by a first control unit, and the second target parameter being used to determine a second power consumption parameter controlled by a second control unit;
in response to the processing unit sending the first target parameter to the first control unit, adjusting, via the first control unit, the first power consumption parameter based on the first target parameter; and
in response to the processing unit sending the second target parameter to the second control unit, adjusting, via the second control unit, the second power consumption parameter based on the second target parameter.

20. The non-transitory computer-readable storage medium of claim 19, wherein determining, by the processing unit, the first target parameter and the second target parameter based on the state parameter includes:
determining, by the processing unit, target parameters for determining power consumption of the electronic device based on the state parameters, wherein the target parameters include a power consumption level of the electronic device; and
determining, by the processing unit, the power consumption level in the target parameters as the second target parameter.
